(19) United States
(12) Patent Application Publication
(10) Pub. No.: US 2013/0285905 A1
(43) Pub. Date: Oct. 31, 2013

(54) THREE-DIMENSIONAL POINTING DEVICE AND SYSTEM

(71) Applicant: Chun-Liang Tsai, Pingtung City (TW)

(72) Inventor: Chun-Liang Tsai, Pingtung City (TW)

(73) Assignee: FAVEPC Inc., Jhubei City (TW)

(21) Appl. No.: 13/459,998

(22) Filed: Apr. 30, 2012

(51) Int. Cl. G06F 3/01; G06F 3/033

(52) U.S. Cl. 345/158; 345/156

(57) ABSTRACT

A device that comprises at least one image sensor and a processing unit. The at least one image sensor is configured to consecutively capture a plurality of images at a predetermined rate. The processing unit is configured to identify in each of the plurality of images a first region and a second region, wherein intensities of the first region and the second region are different; determine a displacement of the first region from the first image of the plurality of images to the last image of the plurality of images; and output a first signal comprising the displacement.

### BACKGROUND OF THE INVENTION

The present invention relates generally to three-dimensional (3D) pointing devices, techniques and systems.

A conventional 3D pointing device may generally have a rotational sensor and an accelerometer for generating outputs which a processor may use to determine the movement of the 3D pointing device. However, the costs associated with the rotational sensor and the accelerometer are high, and the calculation involved for determining the movement is complicated.

On the other hand, a system having a hand-held remote and a set of markers disposed on a display device, which the hand-held remote points at and displays a pointer whose movement is controlled by the hand-held remote, was disclosed. The hand-held remote has an image sensor, an emitter and a processor. The markers may be retro-reflectors, which reflect the light emitted by the emitter in the hand-held remote, and the reflected light is captured by the image sensor to form images of the retro-reflectors and the display device for the processor to determine the position of the hand-held remote relative to the display device. The system has the disadvantage of that the hand-held remote may only function with display devices that have a set of markers disposed thereon in a predefined configuration, so that the movement of the hand-held device may be determined based on the predefined algorithm stored in the hand-held remote.

### BRIEF SUMMARY OF THE INVENTION

Examples of the present invention may provide a device that comprises at least one image sensor and a processing unit. The at least one image sensor is configured to consecutively capture a plurality of images at a predetermined rate. The processing unit is configured to identify in each of the plurality of images a first region and a second region, wherein intensities of the first region and the second region are different; determine a displacement of the first region from the first image of the plurality of images to the last image of the plurality of images; and output a first signal comprising the displacement.

Some examples of the present invention may also provide a system that comprises at least one image sensor, a processing unit, and a display device. The at least one image sensor is configured to consecutively capture a plurality of images at a predetermined rate. The processing unit is configured to identify in each of the plurality of images a first region and a second region, wherein intensities of the first region and the second region are different; determine a displacement of the first region from the first image of the plurality of images to the last image of the plurality of images; and output a first signal comprising the displacement. The display device is configured to receive the first signal and displays a pointer on a screen of the display device moving in accordance with the displacement of the first signal.

Other objects, advantages and novel features of the present invention will be drawn from the following detailed embodiments of the present invention with attached drawings.

### BRIEF DESCRIPTION OF THE SEVERAL VIEWS OF THE DRAWINGS

The foregoing summary as well as the following detailed description of the preferred examples of the present invention will be better understood when read in conjunction with the appended drawings. For the purposes of illustrating the invention, there are shown in the drawings examples which are presently preferred. It is understood, however, that the invention is not limited to the precise arrangements and instrumentalities shown. In the drawings:

FIG. 1 is a schematic diagram of a 3D pointing device 100 in accordance with an example of the present invention, and an example of the system 10 which the 3D pointing device 100 may operate in.

FIG. 2 is a flow chart of a method which the 3D pointing device 100 as shown in FIG. 1 may perform to determine movements of the 3D pointing device 100 in accordance with an example of the present invention.

FIG. 3 is a schematic diagram illustrating images obtained and processed by the 3D pointing device 100 illustrated in FIG. 1, and images displayed on the display device 200 at time t₁ and time t₂ in accordance with an example of the present invention.

FIG. 4 is a schematic diagram illustrating images obtained and processed by the 3D pointing device 100 illustrated in FIG. 1, and images displayed on the display device 200 at time t₁ and time t₂ in accordance with another example of the present invention.

FIG. 5 is a schematic diagram illustrating images obtained and processed by the 3D pointing device 100 illustrated in FIG. 1, and images displayed on the display device 200 at time t₁ and time t₂ in accordance with another example of the present invention.

FIG. 6 is a schematic diagram of a 3D pointing device 700 in accordance with an example of the present invention, and an example of the system 70 which the 3D pointing device 700 may operate in.

FIG. 7 is a schematic diagram illustrating images obtained and processed by the imaging device 702 illustrated in FIG. 6, and images displayed on the display device 200 at time t₁ and time t₂ in accordance with an example of the present invention.

FIG. 8 is a schematic diagram of a 3D pointing device 900 in accordance with an example of the present invention.

FIG. 9 is a flow chart of a method which the 3D pointing device 900 as shown in FIG. 8 may perform in accordance with an example of the present invention.

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions. It should be noted that the drawings are made in simplified form and are not drawn to precise scale.

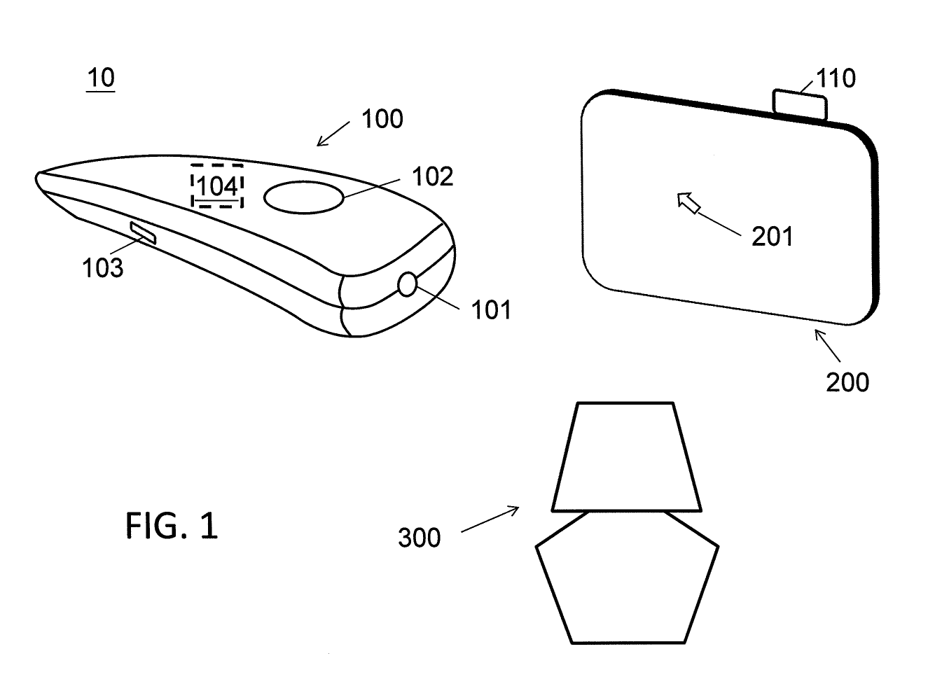

FIG. 1 is a schematic diagram of a 3D pointing device 100 in accordance with an example of the present invention, and an example of the system 10 which the 3D pointing device 100 may operate in. The 3D pointing device 100 may have at least one image sensor 101 and a processing unit 104 for processing the images obtained by the image sensor 101 and providing an output relating to the movements of the 3D pointing device 100 via a communication interface 103. The image sensor 101 may be but is not limited to a complementary metal-oxide-semiconductor (CMOS) sensor or a charged-coupled device (CCD) sensor. The communication interface 103 may be but is not limited to a wireless communication interface, such as a Bluethooth® communication interface or an infra-red (IR) communication interface, or a wired communication interface, such as a Universal Serial Bus (USB) type communication interface.

The 3D pointing device 100 may further have a first button 102 for activating and deactivating the image sensor 101, either directly or through the processing unit 104. In accordance with an example of the present invention, a user of the 3D pointing device 100 may press the first button 102 before he begins to motion the 3D pointing device 100 for moving a pointer 201 on a screen of a display device 200 from a first position to a second position, hold the first button 102 while he motions the 3D pointing device 100, and release the first button 102 when the pointer 201 arrives at the second position, where no further movement is desired. Alternatively, a user may first press-and-release the first button 102 to indicate the start of a pointer movement, and, again, press-and-release the first button 102 to indicate the end of the pointer movement. It will be appreciated by those skilled in the art that the method for indicating the activation and deactivation of the image sensor 101 using the first button 102 may be varied, and is not limited to the examples described herein.

The processing unit 104 may receive the images obtained by the image sensor 101, process the images to determine the movement of the pointer 201 indicated by the user using the 3D pointing device 100, and output a signal containing movement information via the communication interface 103. In addition, the distance between 3D pointing device 100 and an illuminating object 300 may be determined by comparing images obtained by two or more image sensors. The output signal is received by a receiver 110 that is capable of receiving signals from the 3D pointing device 100, and providing the received signal to the display device 200, which is configured to display the pointer movement on the screen in accordance with the received signal.

FIG. 1 illustrates an example in accordance with the present invention where the receiver 110 is connected to the display device 200. It will be appreciated by those skilled in the art that the receiver 110 may also be connected to a computing device, which is in communication with the display device 200, or the receiver 110 may have a wireless communication interface for receiving and transmitting signals from and to the display device 200. Alternatively, the computing device or the display device 200 may have a built-in receiver module which may perform the function of the receiver 110.

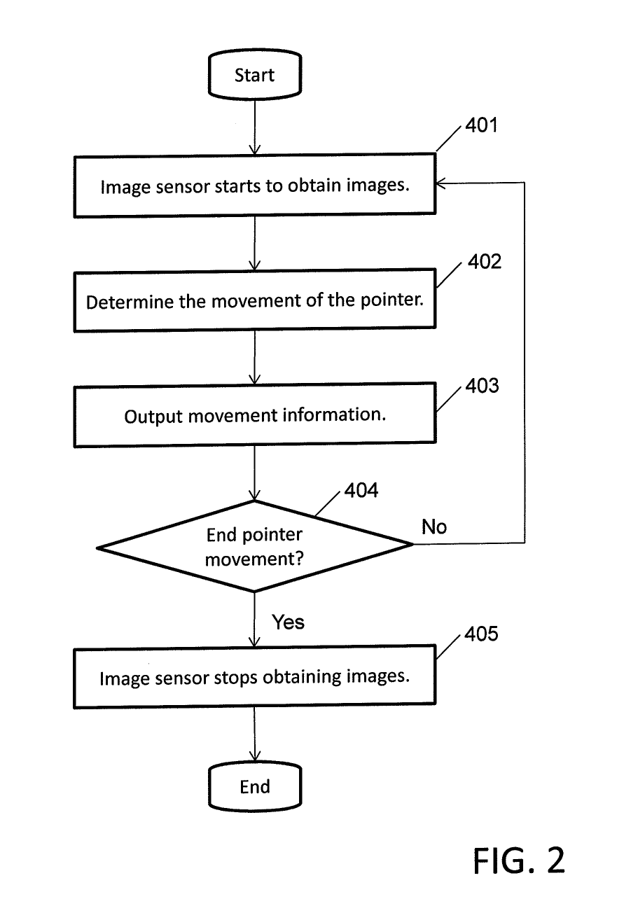

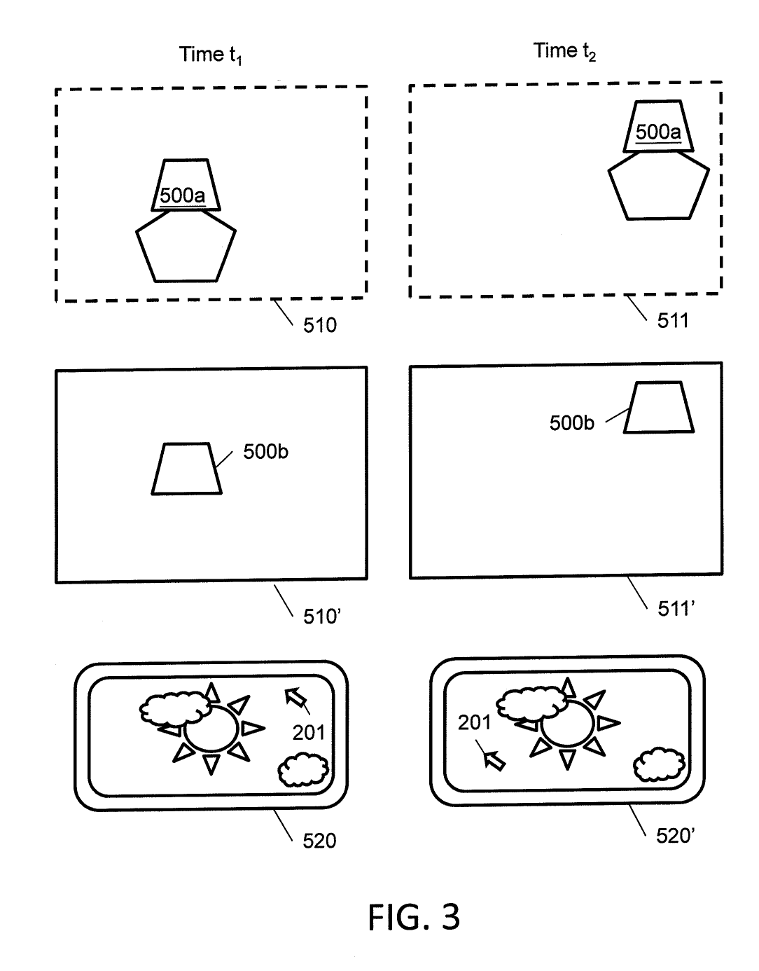

In accordance with an example of the present invention, the 3D pointing device 100 is pointed at the illuminating object 300, which may include but is not limited to a lamp 300, for position reference. An exemplary method for obtaining and processing the images with the 3D pointing device 100 to determine the movements of the 3D pointing device 100 is illustrated in reference to the flow chart in FIG. 2 and the schematic diagrams in FIG. 3.

FIG. 2 is a flow chart of a method which the 3D pointing device 100 as shown in FIG. 1 may perform to determine movements of the 3D pointing device 100 in accordance with an example of the present invention.

The method illustrated in FIG. 2 is performed when the first button 102 sends out a signal indicating that a movement of the 3D pointing device 100 is starting. First, in step 401, the image sensor 101 starts to continuously obtain images at a predetermined rate. The image sensor 101 may obtain images at a rate of approximately 1000 to 3000 frames per second. Subsequently, in step 402, the movement of the 3D pointing device 100, including distance and direction, is determined based on the images captured, and the movement information is output via the communication interface 103 in step 403. The steps 401 to 403 are repeated until an end-of-pointer movement indication is received by the image sensor 101 or the processing unit 104. The image sensor 101 stops obtaining images in step 405 after an end-of pointer movement indication is received.

FIG. 3 is a schematic diagram illustrating images obtained and processed by the 3D pointing device 100 illustrated in FIG. 1, and the images displayed on the display device 200 at time t₁ and time t₂ in accordance with an example of the present invention. As illustrated in FIG. 1, the 3D pointing device 100 points at the lamp 300 to control the movements of the pointer 201 on the display device 200. As the 3D pointing device 100 moves from the first position at time t₁ to the second position at time t₂, the image sensor 101 continuously obtains images.

For example, at time t₁, the pointer 201 is at a first position on the screen of the display device 200 as shown in block 520. The image sensor 101 obtains a first captured image 510. The region 500a in the first image 510 will be brighter than the rest of the image. The processing unit 104 identifies a dark region 500b which surrounds the bright region 500a and produces a first processed image 510′ from the first captured image 510. The first processed image 510′ comprises at least the identified dark region 500b.

Subsequently, the processing unit 104 tracks the movements of the dark region 500b in the subsequent processed images in order to determine the movements of the 3D pointing device 100. For example, at time t₂, the image sensor 101 obtains an Nth captured image 511, and the processing unit 104 obtains an Nth processed image 511′ from the Nth captured image 511. The Nth processed image 511′ also comprises the identified dark region 500b.

By consecutively comparing each of the N processed images obtained between time t₁ to time t₂ with the processed image that immediately follows the respective one of the N processed image, the processing unit 104 may determine the movements of the 3D pointing device 100 based on the displacement of the identified dark region 500b from the first processed image 510′ to the Nth processed image 511′. The displacement of the identified dark region 500b between each pair of consecutive images is determined by way of digital signal processing.

For example, the first processed image 510′ is compared with the second processed image, the second processed image is compare with the third processed image, and the comparison continues until the (N−1)th processed image is compared with the Nth processed image 511′. Movement information including the distance and direction of the movement may be generated and output via the communication interface 103 to the display device 200. The display device 200 then shows the pointer 201 moving from the position shown in block 520 to the position shown in block 520′.

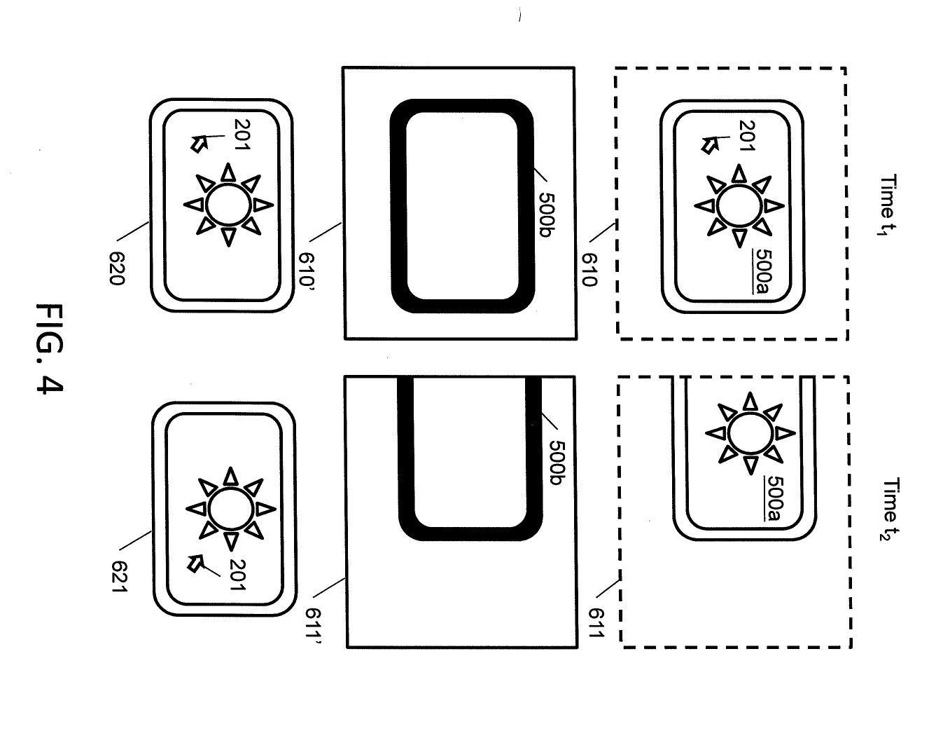

FIG. 4 is a schematic diagram illustrating images obtained and processed by the 3D pointing device 100 illustrated in FIG. 1, and the images displayed on the display device 200 at time t₁ and time t₂ in accordance with another example of the present invention. The example illustrated in FIG. 4 is similar to the example illustrated in FIG. 3, except that the illuminating object which the 3D pointing device points at for position reference is the display device 200, instead of the lamp 300.

For example, at time t₁, the pointer 201 is at a first position on the screen of the display device 200 as shown in block 620. The image sensor 101 obtains a first captured image 610. The processing unit 104 may identify the screen of the display device 200 as the bright region 500a, and the boarder of the display device as the dark region 500b, and produces a first processed image 610′ which comprises at least the identified dark region 500b. The processing unit 104 tracks the displacement of the dark region 500b to determine the movement of the 3D pointing device 100. For example, at time t₂, the image sensor 101 obtains an Nth captured image 611, and the processing unit 104 obtains an Nth processed image 611′ from the Nth captured image 611. The Nth processed image 611′ also comprises the identified dark region 500b, which partially surrounds the bright region 500a.

By consecutively comparing each of the N processed images obtained between time t₁ to time t₂ with the processed image that immediately follows the respective one of the N processed image, the processing unit 104 may determine the movements of the 3D pointing device 100 based on the displacement of the identified dark region 500b from the first processed image 610′ to the Nth processed image 611′.

Movement information including the distance and direction of the movement may be generated and output via the communication interface 103 to the display device 200. The display device 200 then shows the pointer 201 moving from the position shown in block 620 to the position shown in block 621.

A signal having the displacement of the dark region 500b is transmitted to the display device 200 via the communication interface 103 and the receiver 110, and the display device 200 displays the pointer 201 moving in accordance with the displacement in the received signal.

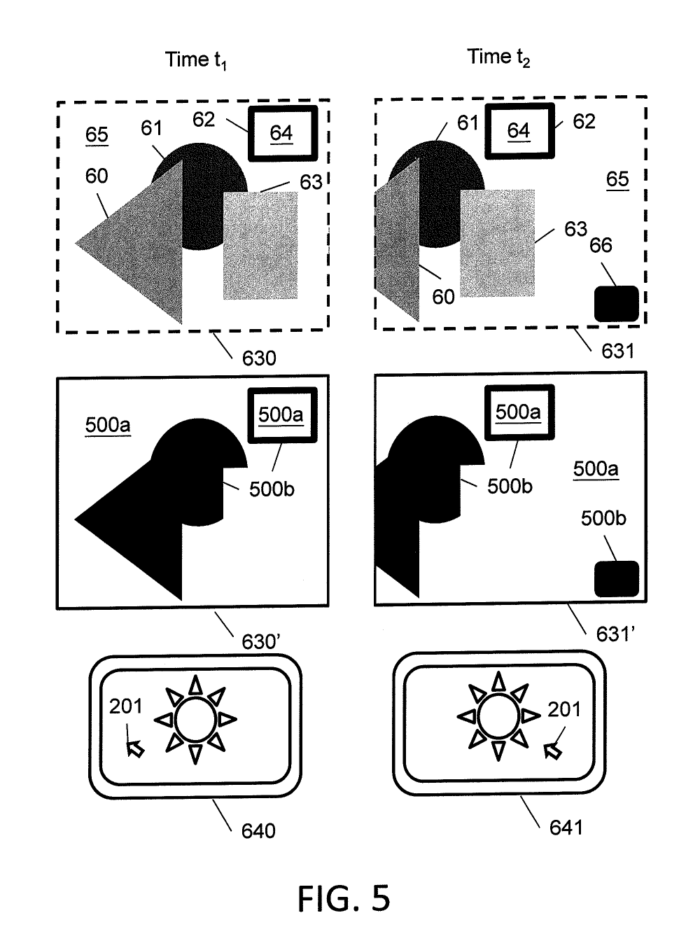

FIG. 5 is a schematic diagram illustrating images obtained and processed by the 3D pointing device 100 illustrated in FIG. 1, and the images displayed on the display device 200 at time t₁ and time t₂ in accordance with another example of the present invention. The example illustrated in FIG. 5 is similar to the examples illustrated in FIGS. 3 and 4, except that the object which the 3D pointing device points at for position reference is not an illuminating object, but is a wall with prints. As the 3D pointing device 100 moves from a first position at time t₁ to a second position at time t₂, the image sensor 101 continuously obtains images.

For example, at time t₁, the pointer 201 is at a first position on the screen of the display device 200 as shown in block 640. The image sensor 101 obtains a first captured image 630. The first captured image 630 comprises a plurality of regions 60, 61, 62, 63, 64, 65, and the brightness, luminance and intensity of each region 60, 61, 62, 63, 64, 65 is different from the brightness, luminance and intensity of at least one other region 60, 61, 62, 63, 64, 65. By comparing the brightness, luminance or intensity of each of the plurality of regions 60, 61, 62, 63, 64, 65 with a predetermined threshold value, the processing unit 104 may produce a first processed image 630′, which comprises a plurality of bright regions 500a and a plurality of dark regions 500b.

For example, the processing unit 104 may compare the intensity of each region 60, 61, 62, 63, 64, 65 with a predetermined threshold value. In the example illustrated in FIG. 5, the intensities of region 60, region 61 and region 62 in the first captured image 630 are found to be greater than or equal to the predetermined threshold. Therefore, region 60, region 61 and region 62 in the first captured image 630 are represented as the plurality of dark regions 500b in the first processed image 630′. On the other hand, the intensity of region 63, region 64 and region 65 are found to be lower than the predetermined threshold, and are, thus, represented as the plurality of bright regions 500a in the first processed image 630′.

Subsequently, the processing unit 104 tracks the movements of the dark region 500b in the subsequent processed images in order to determine the movements of the 3D pointing device 100. For example, at time t₂, the image sensor 101 obtains an Nth captured image 631, which comprises region 60, region 61, region 62, region 63, region 64, region 65 and region 66. The processing unit 104 obtains an Nth processed image 631′ from the Nth captured image 631. The Nth processed image 631′ also comprises a plurality of dark regions 500b and a plurality of bright regions 500a.

By consecutively comparing each of the N processed images obtained between time t₁ to time t₂ with the processed image that immediately follows the respective one of the N processed image, the processing unit 104 may determine the movements of the 3D pointing device 100 based on the displacement of the plurality of dark regions 500b from the first processed image 630′ to the Nth processed image 631′. Movement information including the distance and direction of the movement may be generated and output via the communication interface 103 to the display device 200. The display device 200 then shows the pointer 201 moving from the position shown in block 640 to the position shown in block 641.

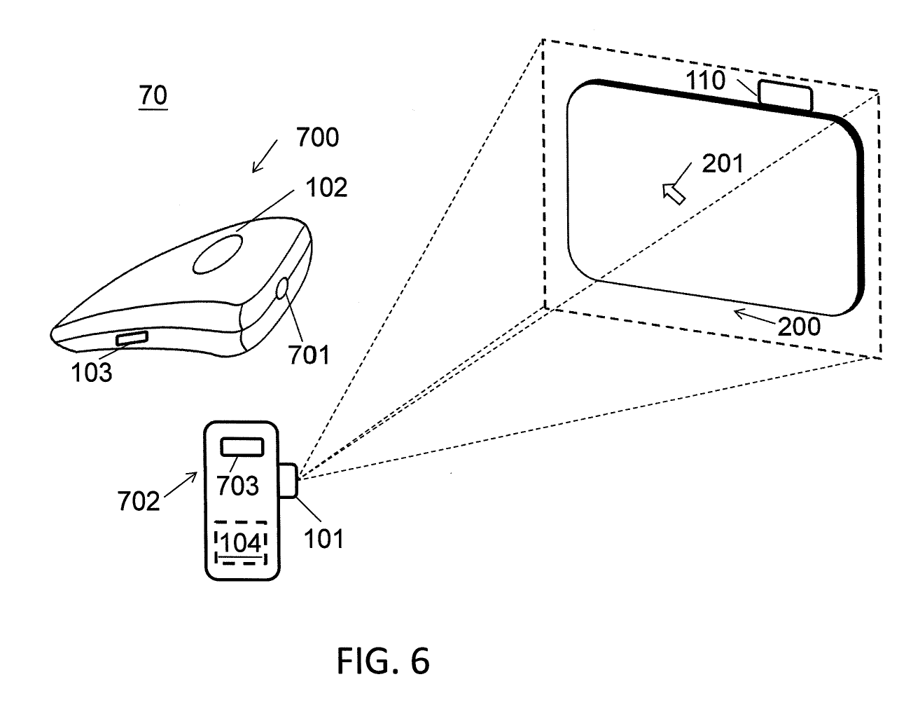

FIG. 6 is a schematic diagram of a 3D pointing device 700 in accordance with an example of the present invention, and an example of the system 70 which the 3D pointing device 700 may operate in. The 3D pointing device 700 is similar to the 3D pointing device 100 illustrated in FIG. 1, except that the 3D pointing device 700 in FIG. 6 comprises a light-emitting unit 701, such as a light-emitting diode (LED). Furthermore, the image sensor 101 and the processing unit 104 are disposed in an image capturing device 702, instead of the 3D pointing device 700. The first button 102 is configured to turn the light-emitting unit 701 on and off.

The image capturing device 702 further comprises a communication interface 703, which is capable of communicating with the communication interface 103 of the 3D pointing device 700. When the light-emitting unit 701 is turned on by the first button 102, a signal is sent from the 3D pointing device 700 to the image capturing device 702 via the communication interfaces 103 and 703, so that the image sensor 101 may start to continuously obtain images at a predetermined rate. The image capturing device 702 is set up so that it may capture images of a space, in which a light spot formed by the light-emitting unit 701 moves around when the light-emitting unit 701 is being used for controlling the movement of the pointer 201 displayed in the display device 200. In an example in accordance with the present invention, the image capturing device 702 may be set up to capture images of the entire display device 200 as illustrated in FIG. 6. The image capturing device 702 may be integrated in other mobile devices, such as notebook computers or tablets. For example, the image capturing device 702 may be disposed behind the screen of a notebook computer, and be capable of capturing images of a space in front of the notebook computer where a light spot formed by the light-emitting unit 701 moves around.

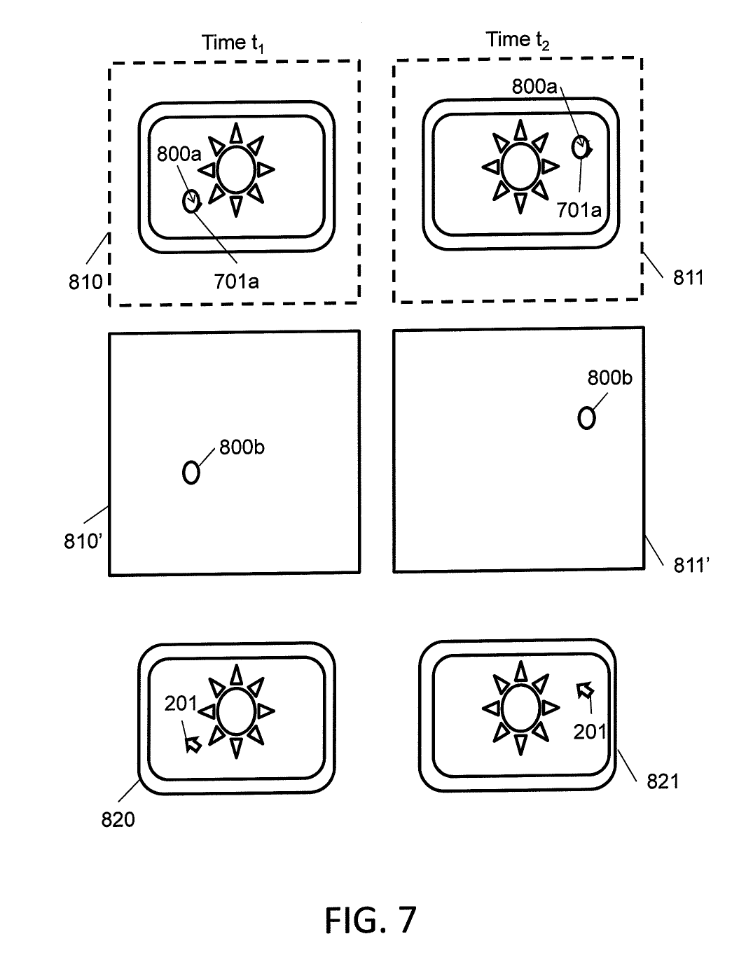

FIG. 7 is a schematic diagram illustrating images processed by the image capturing device 702 illustrated in FIG. 6, and the images displayed on the display device 200 at time t₁ and time t₂ in accordance with an example of the present invention. When the 3D pointing device 700 points at the screen of the display device 200, the light-emitting unit 701 forms a light spot 701a on the screen. The light spot 701a forms a region 800a on the screen which has a brightness, luminance or intensity that is different from the rest of screen.

At time t₁, for example, the image capturing device 702 obtains a first captured image 810, and the processing unit 104 obtains a first processed image 810′ from the first captured image 810 by identifying a dark region 800b surrounding the bright region 800a. At time t₂, the image capturing device 702 obtains an Nth captured image 811, and the processing unit 104 obtains an Nth processed image 811′ form the Nth captured image 811. Based on the images obtained between time t₁ and time t₂, the processing unit 104 may determine the movement of the 3D pointing device 700, and generate movement information including the distance and direction of the movement. The movement information may be provided to the display device 200, so that the pointer 201 may be moved from the position shown in block 820 to the position shown in block 821.

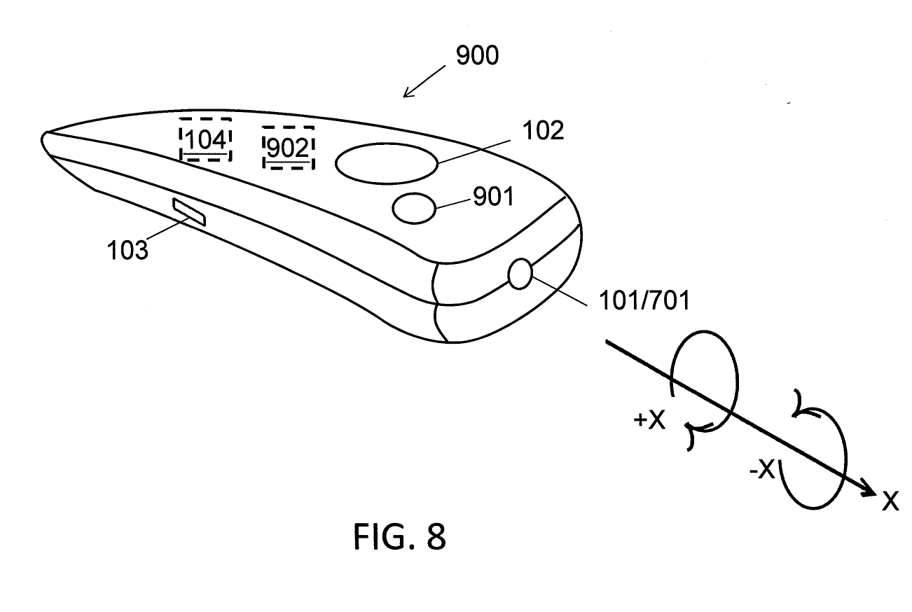

FIG. 8 is a schematic diagram of a 3D pointing device 900 in accordance with an example of the present invention. The 3D pointing device 900 may be similar to the 3D pointing device 100 illustrated in FIG. 1 or the 3D pointing device 700 illustrated in FIG. 6, except that the 3D pointing device 900 illustrated in FIG. 8 further includes an orientation measuring unit 902, such as a gyroscope, and at least one auxiliary button 901. The orientation measuring unit 902 may be configured to measure the roll of the 3D pointing device 900, which is the rotation of the 3D pointing device 900 about an x-axis as shown in FIG. 8. The auxiliary button 901 may be configured to signal activation and/or deactivation of the orientation measuring unit 902. A rotation in the positive-x (+x) direction, a rotation in the negative-x (−x) direction, and a predefined sequence of rotations in either the +x or −x direction, may each be associated with a predefined function, such as opening or closing a folder or selection of an icon displayed on the screen.

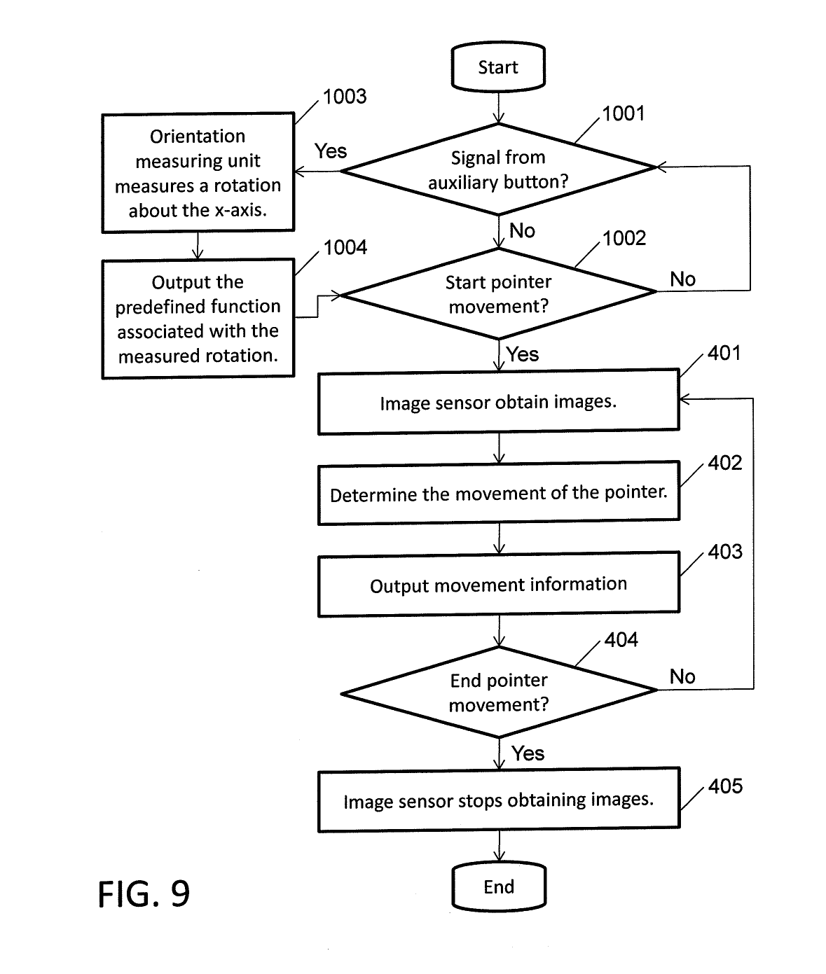

FIG. 9 is a flow chart of a method which the 3D pointing device 900 as shown in FIG. 8 may perform in accordance with an example of the present invention. In step 1001, the processing unit 104 determines whether or not the auxiliary button 901 sends out an activation signal. If YES, in step 1003, the orientation measuring unit 902 measures at least one rotation angle about the x-axis, and then in step 1004, the processing unit 104 outputs a signal to the display device 200 indicating a predefined function associated with the rotation or sequence of rotations measured by the orientation measuring unit 902. If NO, the processing unit 104 determines whether or not the first button 102 sends out a signal indicating the start of a 3D pointing device 900 movement. If NO, the processing unit 104 returns to step 1001. In another example in accordance with the present invention, the processing unit 104 may idle if no activation signal is received from either the first button 102 or the auxiliary button 901. If a signal which indicates the start of a 3D pointing device 900 movement is received from the first button 102, the method illustrated in FIG. 2 may be performed.

The 3D pointing devices 100, 700, 900 in accordance with the present invention provide users the ability to control a pointer on a display device from an arbitrary location. For example, unlike a conventional optical mouse which must be used on a flat surface, the 3D pointing devices 100, 700, 900 in accordance with the present invention may be motioned in the air. Furthermore, the distance between the 3D pointing devices 100, 900 and the illuminating object 300, and the distance between the 3D pointing devices 700, 900 and the space, in which a light spot formed by the light-emitting unit 701 moves around when the 3D pointing device 700, 900 is being used for controlling the movement of the pointer 201 displayed in the display device 200, may range from 0.5 to 8 meter (m). One of ordinary skill in the art would appreciate that the 3D pointing device 100, 900 may, for example, further comprise a lens system for providing variable focal length, so that the range of the distance between the 3D pointing device 100, 900 and the illuminating object 300 may be further expanded or customized.

The 3D pointing devices and systems in accordance with the present invention described in the examples provides versatile uses. For instance, it may be used with any display device that has a communication interface that is compatible with the signal output interface of the receiver or compatible with a communication interface of a computing device. Alternatively, the 3D pointing devices 100, 900 may transmit the signal containing movement information via a Bluethooth® communication interface to a smart TV or computer which comprises a Bluethooth® communication interface, so as to control the movement of the pointer 201 without an external receiver.

In describing representative examples of the present invention, the specification may have presented the method and/or process of operating the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A device comprising:
at least one image sensor configured to consecutively capture a plurality of images at a predetermined rate; and
a processing unit configured to:
identify in each of the plurality of images a first region and a second region, wherein intensities of the first region and the second region are different;
determine a displacement of the first region from the first image of the plurality of images to the last image of the plurality of images; and
output a first signal associated with the displacement.

2. The device of claim 1, wherein the processing unit determines the displacement of the first region by consecutively comparing each of the plurality of images with the image that follows the respective one of the plurality of images, and determining the displacement of the first region between each pair of consecutive images.

3. The device of claim 1 further comprises a first button for triggering and stopping the at least one image sensor.

4. The device of claim 1 further comprises a wireless communication interface or a wired communication interface for outputting the first signal.

5. The device of claim 4, wherein the wireless communication interface is a Bluethooth® communication interface or an infra-red communication interface and the wired communication interface is a Universal Serial Bus (USB) type communication interface.

6. The device of claim 1 further comprises an orientation measuring unit for measuring at least a roll of the device.

7. The device of claim 6, wherein the orientation measuring unit comprises a gyroscope.

8. The device of claim 6 further comprises a second button for activating and deactivating the orientation measuring unit.

9. The device of claim 6, wherein the processing unit is configured to:
receive, from the orientation measuring unit, one or more measured roll angles; and
output a second signal comprising a predetermined function associated with the one or more measured roll angles.

10. The device of claim 1, wherein the first region at least partially surrounds the second region.

11. The device of claim 1, wherein the intensity of the first region is greater than the intensity of the second region.

12. The device of claim 1, wherein the intensity of the first region is less than the intensity of the second region.

13. A system comprising:
a pointing device, wherein the pointing device comprises a light-emitting unit; and
an image-capturing device, wherein the image-capturing unit comprises:
at least one image sensor configured to consecutively capture a plurality of images at a predetermined rate; and
a processing unit configured to:
identify in each of the plurality of images a first region and a second region, wherein intensities of the first region and the second region are different;
determine a displacement of the first region from the first image of the plurality of images to the last image of the plurality of images; and
output a first signal associated with the displacement;

14. The system of claim 13, wherein the processing unit determines the displacement of the first region by consecutively comparing each of the plurality of images with the image that follows the respective one of the plurality of images, and determining the displacement of the first region between each pair of consecutive images.

15. The system of claim 13, wherein
the pointing device further comprises a first wireless communication interface or a first wired communication interface for transmitting a second signal when the light-emitting unit is activated and a third signal when the light-emitting unit is deactivated;
the image-capturing device further comprises a second wireless communication interface or a second wired communication interface for receiving the second signal and the third signal, and transmitting the second signal and the third signal to the processing unit; and
the processing unit is further configured to activate and deactivate the at least one image sensor in response to the second signal and the third signal, respectively.

16. The system of claim 13 further comprises a first button for activating and deactivating the light-emitting unit.

17. The system of claim 13 further comprises a display device configured to receive the first signal and displays a pointer on a screen of the display device moving in accordance with the displacement of the first signal.

18. The system of claim 17 further comprises a receiver configured to receive the first signal and transmit the first signal to the display device.

19. The system of claim 13, wherein the pointing device further comprises an orientation measuring unit for measuring at least a roll of a pointing device.

20. The system of claim 19, wherein the orientation measuring unit comprises a gyroscope.

21. The system of claim 19 further comprises a second button for activating and deactivating the orientation measuring unit.

22. The system of claim 19, wherein the processing unit is configured to:
receive, from the orientation measuring unit, one or more measured roll angles; and
outputs a fourth signal comprising a predetermined function associated with the one or more measured roll angles.

23. The device of claim 13, wherein the first region at least partially surrounds the second region.

24. The device of claim 13, wherein the intensity of the first region is greater than the intensity of the second region.

25. The device of claim 13, wherein the intensity of the first region is less than the intensity of the second region.
